(19) United States
(12) Patent Application Publication
(10) Pub. No.: US 2021/0303212 A1
(43) Pub. Date: Sep. 30, 2021

(54) Data processing method and memory controller utilizing the same

(71) Applicant: Realtek Semiconductor Corp., HsinChu (TW)

(72) Inventors: Yen-Chung Chen, HsinChu (TW); Yi-Ting Wei, HsinChu (TW); Fu-Hsin Chen, HsinChu (TW); SEK WANG LAM, HsinChu (TW)

(21) Appl. No.: 17/158,016

(22) Filed: Jan. 26, 2021

(30) Foreign Application Priority Data
Mar. 30, 2020 (CN) 202010234589.7

(51) Int. Cl. G06F 3/06

(52) U.S. Cl. CPC G06F 3/0659; G06F 3/0679; G06F 3/0604

(57) ABSTRACT

A data processing method includes: configuring a predetermined memory space to record information regarding valid data of a memory device, where the information is used to indicate data associated to which logical memory spaces of the memory device is valid; and updating the information according to commands received from a host device.

### BACKGROUND OF THE INVENTION

### 1. Field of the Invention

The invention relates to a data processing method, more particular to a data processing method for recording information regarding valid data in a memory device in real-time.

### 2. Description of the Prior Art

Users sometimes need to replace the old hard disk or solid state drive (SSD) in the computer with a new hard disk or SSD. However, the old device stores both valid data and invalid data. If all the data stored in the old device is directly copied to the new device, it will take a very long time to complete the copy operation there is a huge amount of data to be copied. In addition, when the copy operation has completed, the access efficiency of the new device degrades since the new device has already stored a huge amount of data, including the invalid data.

To solve this problem, a data processing method for improving efficiency of the data copy operation is proposed.

### SUMMARY OF THE INVENTION

It is an objective of the invention to provide a data processing method that is capable of improving efficiency of the data copy operation and solving the aforementioned problem. The spirit of the proposed method is to use the memory controller configured in the storage device to record the valid data information in real-time and keep updating the valid data information according to the access operations of the memory device. When performing data copy is required, by actively providing the valid data information, the efficiency of performing data copy can be greatly improved as compared to the conventional design.

According to an embodiment of the invention, a memory controller coupled to a memory device comprises a host interface arranged to receive a plurality of commands from a host device and a processor. The processor is coupled to the host interface and arranged to record information regarding valid data of the memory device. The processor is arranged to configure a predetermined memory space for storing the information and update the information according to the commands.

According to another embodiment of the invention, a data processing method comprises: configuring a predetermined memory space to record information regarding valid data of a memory device; and updating the information according to a plurality of commands received from a host device, wherein the information is used to indicate data associated to which logical memory spaces of the memory device is valid.

With the aid of the valid data information provided by the memory controller, the host device or a specific data copy software is capable of correctly recognizing the data associated with which logical memory spaces of the memory device is valid data. In this manner, the data copy can be performed in a more efficient and simple way and the problem of data copy in the conventional design can be solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system according to an embodiment of the invention.

FIG. 2 is an exemplary block diagram of a memory controller according to an embodiment of the invention.

FIG. 3 is a flow chart of a data processing method according to an embodiment of the invention.

FIG. 4 is a schematic diagram showing the memory mapping between the predetermined memory space recording the valid data information and the memory space of the memory device according to an embodiment of the invention.

FIG. 5 is a schematic diagram showing the memory copy operation according to an embodiment of the invention.

### DETAILED DESCRIPTION

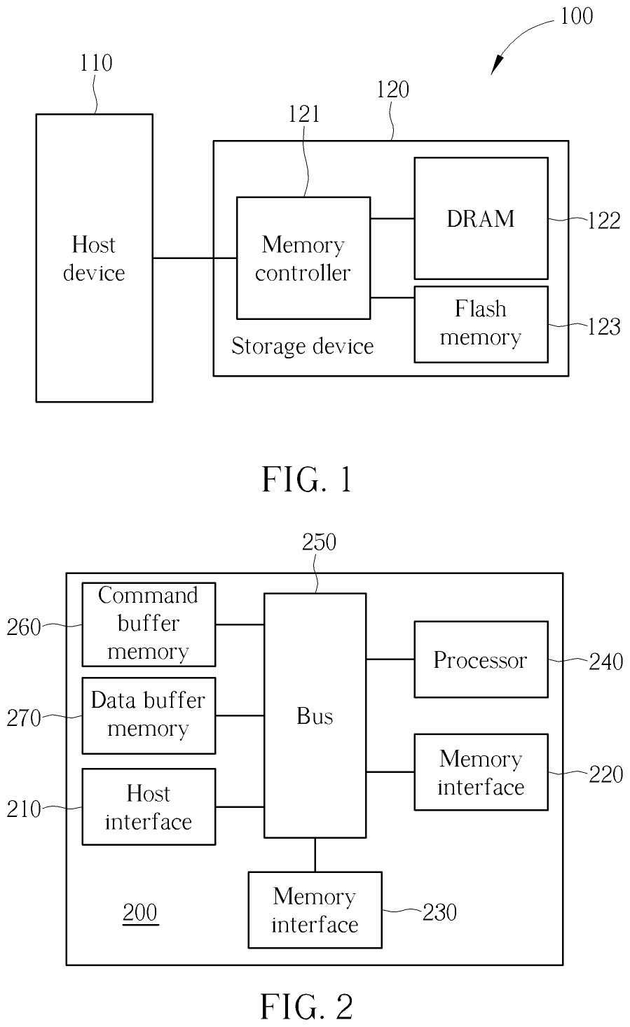

FIG. 1 is a block diagram of a system according to an embodiment of the invention. The system may be a data storage system, a computer system or an electronic product system. The system 100 may comprise a host device 110 and a storage device 120. The storage device 120 may comprise a memory controller 121 and one or more memory devices. According to an embodiment of the invention, the storage device 120 may be a Solid State Drive (SSD) configured inside of the electronic product or connected to the electronic product. The memory controller 121 may be coupled to said one or more memory devices. The memory devices may be the Dynamic Random Access Memory (DRAM) 122 and flash memory 123 as shown in FIG. 1, and the flash memory 123 may comprise a plurality of flash memory module. The memory controller 121 may access the DRAM 122 and flash memory 123 via the corresponding interfaces. The memory controller 121 may also communicate with the host device 110 via the corresponding interface, for receiving a plurality of commands and performing corresponding memory access operations in response to the commands.

It should be noted that FIG. 1 presents a simplified block diagram in which only the components relevant to the invention are shown. As will be readily appreciated by a person of ordinary skill in the art, an electronic product system may further comprise other components not shown in FIG. 1 and arranged to implement a variety of functions.

FIG. 2 is an exemplary block diagram of a memory controller according to an embodiment of the invention. The memory controller 200 may be one of a variety of implementations of the memory controller 121 shown in FIG. 1. The memory controller 200 may comprise a plurality of interfaces, such as the host interface 210 and the memory interfaces 220 and 230. The memory controller 200 may communicate with peripheral devices via the aforementioned interfaces. The host interface 210 may be implemented by a controller, such as a Peripheral Component Interconnect (PCI) Express (PCI-E) interface/Serial Advanced Technology Attachment (SATA) controller, and is arranged to control the communication signals transmitted between the memory controller 200 and the host device 110 via the corresponding hardware interface. The memory controller 200 may receive a plurality of commands from the host device 110 via the host interface 210. The memory interface 220 may be implemented by a DRAM controller, and is arranged to control the communication signals transmitted between the memory controller 121/200 and the DRAM 122 via the corresponding hardware interface. The memory interface 230 may be implemented by a flash memory controller, and is arranged to control the communication signals transmitted between the memory controller 121/200 and the flash memory 123 via the corresponding hardware interface.

The memory controller 200 may further comprise a processor 240, a bus 250, a command buffer memory 260 and a data buffer memory 270. The processor 240 is arranged to communicate with the peripheral devices via the bus 250 and the aforementioned interfaces. The bus 250 may operate in compliance with the Open Core Protocol (OCP) and may be utilized to connect the devices such as the host interface 210, the memory interfaces 220 and 230, the processor 240, the command buffer memory 260 and the data buffer memory 270, so that they can communicate and collaborate with each other. The command buffer memory 260 and the data buffer memory 270 may be utilized to perform the command and data buffering required by the memory controller 200. The command buffer memory 260 and the data buffer memory 270 may be implemented by RAM, such as the static RAM (SRAM), but the invention should not be limited thereto.

It should be noted that FIG. 2 presents a simplified block diagram in which only the components relevant to the invention are shown. As will be readily appreciated by a person of ordinary skill in the art, a memory controller may further comprise other components not shown in FIG. 2 and arranged to implement a variety of functions.

According to an embodiment of the invention, the processor 240 may configure a predetermined memory space for storing the information regarding valid data of the memory device (such as the flash memory 123), and may keep updating the information according to access operations of the memory device. Since the access operations are controlled by the memory controller 121/200, the processor 240 may record the information regarding valid data of the memory device in real-time according to the latest access operations. For example, the processor 240 may keep updating the information regarding the valid data according to the commands received from the host device 110.

In the embodiments of the invention, the information regarding valid data of the memory device (such as the flash memory 123) is utilized to indicate data associated with which logical memory spaces of the memory device is valid data, wherein the data associated with a logical memory space may be the data logically stored in the logical memory space. Generally, the memory space of the memory device may be divided into a plurality of logical memory spaces by the host device 110. Each logical memory space may be addressed by the Logical Block Address (LBA). The data logically stored in one logical memory space may be physically stored in one or more physical memory spaces of the memory device. When the data associated with a logical memory space is deleted by the user, the data physically stored in the memory device may not be deleted.

For example, when the user deletes or moves the files stored in the logical memory space A to the logical memory space B by operating the host device 110, the files stored in the logical memory space A become invalid data due to such delete or move operation. In other words, the data associated with the logical memory space A becomes invalid. However, the invalid data may still physically occupy some memory space of the memory device, and may have not been erased yet. Therefore, when the user wants to copy all the data of the memory device (all the data seen from the user's point of view) to another memory device, those files may be copied to said another memory device during the whole-disc copy operation because they may still be stored in the memory device or may still be recorded as associated with the logical memory space A, causing the aforementioned inefficient problem.

To solve the aforementioned problem, in the embodiments of the invention, the processor 240 may keep recording the information regarding valid data (i.e. the valid data information) of the memory device (such as the flash memory 123) according to the latest access operation of the memory device. With the aid of the valid data information, the host device 110 or a specific data copy software is capable of correctly recognizing the data associated with which logical memory spaces of the memory device is valid data. In this manner, when performing data copy is required, by actively providing the valid data information to the host device 110 or the specific data copy software, the efficiency of performing data copy can be greatly improved as compared to the conventional design. Here, the aforementioned data copy software may be the software jointly developed with the proposed memory controller 121/200.

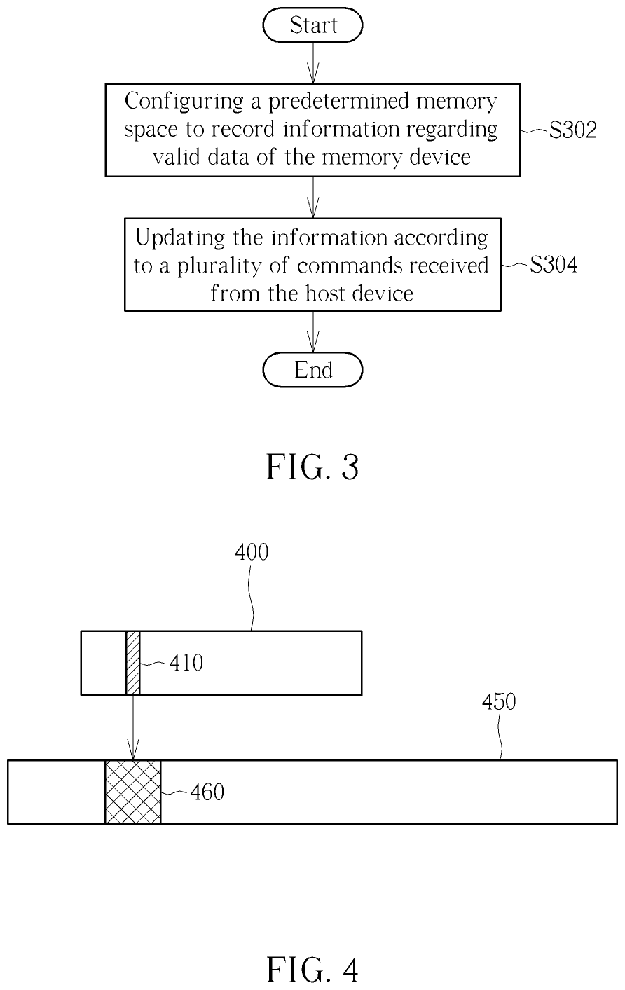

FIG. 3 is a flow chart of a data processing method according to an embodiment of the invention. The data processing method may be performed by memory controller 121/200 or the processor 240, and may comprise the following steps:

Step S302: configuring a predetermined memory space to record information regarding valid data of a memory device (such as the flash memory 123). According to an embodiment of the invention, the memory controller 121/200 may configure the aforementioned predetermined memory space in the DRAM 122, the flash memory 123 or in its internal memory device (such as the data buffer memory 270). When the memory controller 121/200 configures the aforementioned predetermined memory space in a volatile memory such as the DRAM or SRAM, the memory controller 121/200 may further store the data recorded in the aforementioned predetermined memory space in the flash memory 123 before power-off, so as to preserve the data recorded therein.

Step S304: updating the information according to a plurality of commands received from the host device. As discussed above, the processor 240 may record or update the information regarding valid data of the memory device in real-time according to the received commands or the latest access operations.

According to an embodiment of the invention, the aforementioned predetermined memory space may comprise a plurality of memory units and each memory unit may correspond to a logical memory space of the memory device. In addition, the logical memory space may cover one or more consecutive logical block addresses (LBAs).

In addition, according to an embodiment of the invention, the valid data information may be represented by a plurality of bits. Each bit may be associated with one memory unit, and the memory device 121/200 may record the valid data information by setting values corresponding to the bits.

FIG. 4 is a schematic diagram showing the memory mapping between the predetermined memory space 400 recording the valid data information and the memory space 450 of the memory device (such as the flash memory 123) according to an embodiment of the invention. According to an embodiment of the invention, the predetermined memory space 400 may comprise a plurality of memory units, such as the memory unit 410. In an embodiment of the invention, each memory unit may be one bit, and the plurality of memory units comprised in the predetermined memory space 400 may form a bit map to record the valid data information of the memory device.

According to an embodiment of the invention, each memory unit or each bit may represent a consecutive logical memory space (such as the logical memory space 460 shown in FIG. 4) of the memory device (such as the flash memory 123), wherein the size of one consecutive logical memory space may be set to, for example, 4 Kilobytes (KB), or set to the size of a logical block addressed by one LBA. Depending on the system requirements, the size of one logical block may be 512 bytes, 1024 bytes or 4 K bytes.

According to an embodiment of the invention, one memory unit may correspond to a plurality of logical addresses, therefore, there is a one-to-many relationship between memory unit and logical addresses. In other words, in the embodiments of the invention, the data recorded in the predetermined memory space 400 may be compressed data. The memory controller 121/200 may completely record the valid data information of the whole memory spaces of the memory device (such as the flash memory 123) by simply using a relative small memory space.

For example, suppose that the memory controller 121/200 uses one bit to represent the memory space of 4 K bytes, and suppose that the overall size of the memory device (for example, the size of the memory space 450) is 256 Gigabyte (GB), the number of bits required to completely record the valid data information of the whole memory space of the memory device would be 256 GB/4 Kb=64 million, which is equivalent to a 8 Megabyte (MB) memory space. In other words, the memory controller 121/200 can completely record the valid data information corresponding to a 256 GB memory space with only a 8 MB of memory space.

According to an embodiment of the invention, the commands received by the processor 240 from the host device 110 may comprise a write command. The write command may comprise a starting LBA and a length. In response to reception of the write command, the processor 240 may select one or more bits to be updated according to the starting LBA and the length, and set the value(s) corresponding to said one or more bits to a first value, where the first value is utilized to represent valid data. Or, in another embodiment of the invention, in response to reception of the write command, the processor 240 may calculate a range or an area in the predetermined memory space that has to be marked in response to this write operation according to the starting LBA and the length, and mark a status of the calculated range or area as valid, so as to represent that data currently associated with the memory space of the memory device corresponding to this range or area is valid data.

For example, suppose that the size of data to be written in response to a write command is 128 KB and one bit in the bit map represents a memory space of 4 KB. In response to this write command, the number of bits having the corresponding value to be updated would be 128 K/4 K=32. The processor 240 may determine which bits having the corresponding value to be updated according to the starting LBA and the length of the data to be written, and set the values of the bits to the first value.

According to an embodiment of the invention, the commands received by the processor 240 from the host device 110 may comprise a delete command or a trim command. The delete or trim command may comprise a starting LBA and a length. In response to reception of the delete or trim command, the processor 240 may select one or more bits to be updated according to the starting LBA and the length, and set the value(s) corresponding to said one or more bits to a second value, where the second value is utilized to represent invalid data. Or, in another embodiment of the invention, in response to reception of the delete or trim command, the processor 240 may calculate a range or an area in the predetermined memory space that has to be marked in response to this delete or trim operation according to the starting LBA and the length, and mark a status of the calculated range or area as invalid, so as to represent that data currently associated with the memory space of the memory device corresponding to this range or area is invalid data.

According to an embodiment of the invention, there may be at least two implementations for updating the valid data information. In the first implementation, the processor 240 first determines which bit(s) in the bit map or which range(s) or area(s) in the predetermined memory space have to be updated, reads the content of the predetermined memory space (e.g. predetermined memory space 400) to determine which value or status is currently set or marked for the corresponding bit(s), or range(s) or area(s), and sets the value(s) for the bit(s) that have not been set to the correct value or mark the status(s) for the range(s) or area(s) that have not been marked as the correct status. For example, suppose that the processor 240 determines that the 1^{th}˜8^{th} bits in the bit map have to be updated and knows the values currently set for the 1^{th}˜8^{th} bits are 11110011 by reading the content of the predetermined memory space 400, where the value “1” represents valid data and the value “0” represents invalid data, the processor 240 may only change the values of the 5^{th} and 6^{th} bits as “1” in the first implementation. In the second implementation, after determining which bit(s) in the bit map or which range(s) or area(s) in the predetermined memory space have to be updated, the processor 240 may directly set the value of the bit(s) in the bit map to the correct value or mark the status(s) of the range(s) or area(s) as the correct status, regardless of which value or status was previously set or marked for the corresponding bit(s), or range(s) or area(s). Using the aforementioned example, when the processor 240 determines that the 1^{st}˜8^{th} bits in the bit map have to be updated, the processor 240 directly sets or marks the values corresponding to all of the 1^{th}˜8^{th} bits to “1” regardless of whether the values corresponding to the 1^{th}˜8^{th} bits were previously set to “1” or not.

According to an embodiment of the invention, the commands received by the processor 240 from the host device 110 may further comprise a memory copy command. In response to the reception of the memory copy command, the processor 240 may provide the valid data information that it maintained to the host device 110 via the host interface 210. For example, the processor 240 may provide the content stored in the aforementioned predetermined memory space 400 or provide the aforementioned bit map to the host device 110.

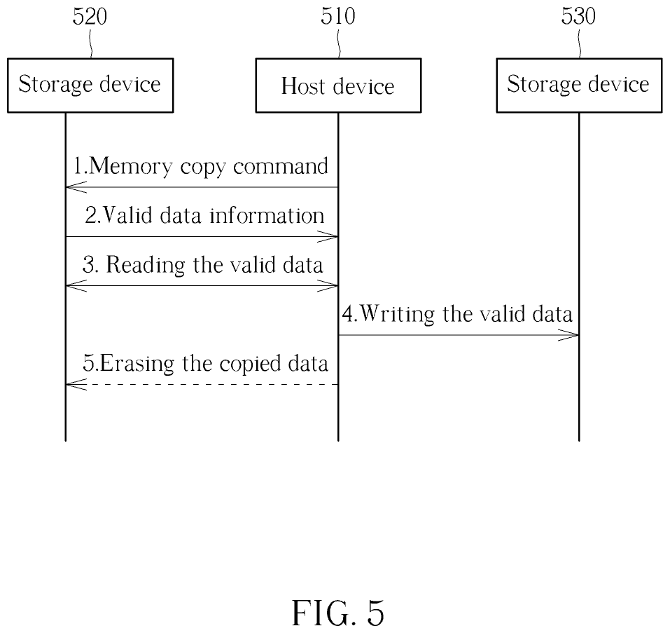

FIG. 5 is a schematic diagram showing the memory copy operation according to an embodiment of the invention. When performing the memory copy operation, there may be three devices comprised in the system, comprising a host device 510 and storage devices 520 and 530. The storage device 520 may be an existing storage device in the system and the storage device 530 may be a new storage device. The host device 510 may perform the memory copy operation by executing the aforementioned data copy software jointly developed with the proposed memory controller 121/200.

First of all, the host device 510 may issue a memory copy command to the existing storage device 520. In response to the memory copy command, the processor 240 may provide the valid data information that it maintained to the host device 510. Upon receiving the valid data information, the host device 510 may read the area storing valid data in the storage device 520 according to the valid data information. For example, the host device 510 may calculate the corresponding logical memory space (for example, the starting LBA and length) according to the indices or locations of the bits being set to the first value (or, the region or area having the status being marked as valid) and access the storage device 520 to read the valid data stored therein. Then, the host device 510 may store the valid data into the storage device 530 according to the corresponding logical memory space where the valid data originally stored in the storage device 520. The operations of reading valid data from the storage device 520 and writing the valid data into the storage device 530 may be repeatedly performed until all the valid data marked by the processor 240 have been copied and written into the storage device 530. Thereafter, the host device 510 may selectively delete the data stored in the storage device 520. For example, the host device 510 may delete the data that has been copied to the storage device 530. It should be noted that FIG. 5 shows a simplified operation flow, and the person with ordinary skilled in the art will be readily appreciated that each operation shown in the figure may be carried out by performing the read/write/erase operation of the memory device in response to one or more commands.

As discussed above, in the proposed data processing method, the memory controller keeps recording the valid data information according to the latest access operation. With the aid of the valid data information, the host device or a specific data copy software is capable of correctly recognizing data associated with which logical memory spaces of the memory device is valid data. In this manner, when performing the data copy is required, the data copy can be performed in a more efficient and simple way by only providing the valid data information to the host device 110 or the specific data copy software and the problem of redundantly copying invalid data which consuming both system resources and operation time in the conventional design can be solved. In addition, since disk backup software in the conventional design needs to analyze the file system supported by the operating system of the computer to obtain corresponding file information, the compatibility of different operating systems must be considered during development of the conventional disk backup software. However, by using the proposed data processing method, with the aid of the valid data information, there will be no need to consider the compatibility of different operating systems when developing the aforementioned jointly developed data copy software.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller coupled to a memory device, comprising:
a host interface, arranged to receive a plurality of commands from a host device; and
a processor, coupled to the host interface and arranged to record information regarding valid data of the memory device, wherein the processor is arranged to configure a predetermined memory space for storing the information and update the information according to the commands.

2. The memory controller of claim 1, wherein the information indicates data associated with which logical memory spaces of the memory device is valid data.

3. The memory controller of claim 1, wherein the processor is further arranged to provide the information to the host device via the host interface in response to a memory copy command.

4. The memory controller of claim 1, wherein the predetermined memory space comprises a plurality of memory units, and each memory unit corresponds to a logical memory space of the memory device.

5. The memory controller of claim 4, wherein the logical memory space covers one or more consecutive logical block addresses (LBAs).

6. The memory controller of claim 4, wherein the information is represented by a plurality of bits, each bit is associated with one memory unit, and the processor is arranged to record the information by setting values corresponding to the bits.

7. The memory controller of claim 6, wherein the commands comprises a write command, the write command comprises a starting LBA and a length, and in response to reception of the write command, the processor is arranged to select one or more of the bits according to the starting LBA and the length, and set the value(s) corresponding to said one or more of the bits to a first value.

8. The memory controller of claim 6, wherein the commands comprise a delete command, the delete command comprises a starting LBA and a length, and in response to reception of the delete command, the processor is arranged to select one or more of the bits according to the starting LBA and the length, and set the value(s) corresponding to said one or more of the bits to a second value.

9. A data processing method, comprising
configuring a predetermined memory space to record information regarding valid data of a memory device; and
updating the information according to a plurality of commands received from a host device,
wherein the information is used to indicate data associated to which logical memory spaces of the memory device is valid.

10. The data processing method of claim 9, further comprising:
providing the information to the host device via a host interface in response to reception of a memory copy command.

11. The data processing method of claim 9, wherein the predetermined memory space comprises a plurality of memory units, and each memory unit corresponds to a logical memory space of the memory device.

12. The data processing method of claim 11, wherein the logical memory space covers one or more consecutive logical block addresses (LBAs).

13. The data processing method of claim 11, wherein the information is represented by a plurality of bits, each bit is associated with one memory unit, and the method further comprises:
recording the information by setting values corresponding to the bits.

14. The data processing method of claim 13, wherein the commands comprises a write command, the write command comprises a starting LBA and a length, and a step of updating the information according to the commands received from the host device further comprises:
in response to reception of the write command, selecting one or more of the bits according to the starting LBA and the length; and
setting the value(s) corresponding to said one or more of the bits to a first value.

15. The data processing method of claim 13, wherein the commands comprise a delete command, the delete command comprises a starting LBA and a length, and a step of updating the information according to the commands received from the host device further comprises:
in response to reception of the delete command, selecting one or more of the bits according to the starting LBA and the length; and
setting the value(s) corresponding to said one or more of the bits to a second value.
